(19) United States
(12) Patent Application Publication
(10) Pub. No.: US 2005/0089098 A1
(43) Pub. Date: Apr. 28, 2005

(54) Data processing apparatus and method and encoding device of same

(76) Inventors: Kazushi Sato, Chiba (JP); Yoichi Yagasaki, Tokyo (JP)

Correspondence Address: William E. Vaughan;Bell, Boyd & Lloyd LLC, P.O. Box 1135, Chicago, IL, 60690, US

(21) Appl. No.: 10/948,986

(22) Filed: Sep. 22, 2004

(30) Foreign Application Priority Data
Oct. 1, 2003 (JP) P2003-342888

(51) Int. Cl. H04N 7/12

(52) U.S. Cl. 375/240.16; 375/240.12; 375/240.24

(57) ABSTRACT

A data processing apparatus for determining motion vectors of image data, a method therefor and an encoding device of same are provided. A MPEG2 decoding circuit decodes an image data decoded by MPEG2 to produce image data and outputs a motion vector of each macro-block determined by MPEG2-encoding. A MV-transforming circuit transforms the motion vector to produce motion vector defining a search range of motion vector. A motion prediction and compensation circuit searches the search range defined by the motion vector in a reference image data.

### CROSS REFERENCE TO RELATED APPLICATIONS

This application claims priority to Japanese Patent Application No. P2003-342888, filed on Oct. 1, 2003, the disclosure of which is incorporated by reference herein.

### BACKGROUND OF THE INVENTION

The present invention relates to a data processing apparatus for determining motion vectors of image data, a method therefor and an encoding device of the same.

In recent years, apparatuses utilizing for example the MPEG (Moving Picture Experts Group) or other system handling image data as digital data and utilizing the redundancy unique to image information to compress the data by application of a discrete cosine transform or other orthogonal transform and motion compensation for the purpose of transmitting and storing information with a high efficiency have spread in distribution of information such as broadcasts of broadcast stations and in reception of information in general homes.

After the MPEG system, the encoding system referred to as H264/AVC (Advanced Video Coding) for realizing a further higher compression ratio has been proposed. In the H264/AVC method, in the same way as the MPEG, motion prediction and compensation are performed on the basis of motion vectors. H264/AVC type encoding devices sometimes first decode image data encoded by the MPEG system, then encode it the H264/AVC system. In such case, in the motion prediction and compensation of a H264/AVC encoding device, for example, predetermined reference image data of decoded data obtained by decoding is thinned to produce reference image data having ¼ resolution, and a first motion vector is generated using the entire reference image data of ¼ resolution as the search range. Then, based on this first motion vector, another search range in the predetermined reference image data is determined, and a motion vector is generated again within the that determined search range.

In the conventional H264/AVC encoding device explained above, however, the generation of the motion vectors is accompanied with a large amount of processing so there have been demands for shortening the processing time and reducing the scale of the apparatus. The same problems exist also in non-H264/AVC encoding device in the same way.

### SUMMARY OF THE INVENTION

The present invention provides in an embodiment a data processing apparatus capable of reducing the amount of processing accompanying the determination of motion vectors without causing a deterioration of the encoding efficiency when encoding motion image data by a first encoding method, decoding this encoded data, and encoding the obtained decoded data by a second encoding method and a method and an encoding device of the same.

According to an embodiment of the invention, there is provided a data processing apparatus comprising, a decoding means for decoding a coded data obtained by encoding a moving image data on the basis of a first encoding method to produce a decoded data; and a motion vector generating means for determining a search range in a reference image data on the basis of a first motion vector included in the coded data and searching through the search range in the reference image data to generate a second motion vector of the decoded data to thereby encode the decoded data produced by the decoding means on the basis of a second encoding method different to the first encoding method.

An operation of an embodiment of the invention will be described below.

A decoding means decodes a coded data obtained by encoding a moving image data on the basis of a first encoding method to produce a decoded data.

Then a motion vector generating means determines a search range in a reference image data on the basis of a first motion vector included in the coded data in order to encode the decoded data produced by the decoding means on the basis of a second encoding method which is different to the first encoding method.

Then the motion vector generating means searches through the search range in the reference image data to generate a second motion vector of the decoded data.

According to another embodiment of the invention, there is provided a data processing method comprising, a first step for decoding a coded data obtained by encoding a moving image data on the basis of a first encoding method to produce a decoded data; a second step for determining a search range in a reference image data on the basis of a first motion vector included in the coded data in order to encode the decoded data produced by the first step on the basis of a second encoding method which is different to the first encoding method; and a third step for searching through the search range determined in the second step in the reference image data to generate a second motion vector of the decoded data.

An operation of an embodiment of the invention will be described below.

In a first step, a coded data obtained by encoding a moving image data is decoded on the basis of a first encoding method to produce a decoded data;

In a second step, a search range in a reference image data is determined on the basis of a first motion vector included in the coded data in order to encode the decoded data produced by the first step on the basis of a second encoding method which is different to the first encoding method.

In a third step, the search range determined in the second step in the reference image data is searched through to generate a second motion vector of the decoded data.

According to yet another embodiment of the invention, there is provided a encoding device comprising, a decoding means for decoding an coded data obtained by encoding a moving image data on the basis of a first encoding method to produce a decoded data; a motion prediction means for determining a search range in a reference image data on the basis of a first motion vector included in the coded data and searching through the search range in the reference image data to generate a second motion vector of the decoded data and a prediction image data corresponding to the second motion vector in order to encode the decoded data produced by the decoding means on the basis of a second encoding method which is different to the first encoding method; and a encoding means for encoding a difference between the prediction image data produced by the motion prediction means and the decoded data.

An operation pursuant to an embodiment of the invention will be described below.

A decoding means decodes a coded data obtained by encoding a moving image data on the basis of a first encoding method to produce a decoded data.

Then a motion prediction means determines a search range in a reference image data on the basis of a first motion vector included in the coded data in order to encode the decoded data produced by the decoding means on the basis of a second encoding method which is different to the first encoding method.

Then the motion prediction means searches through the search range in the reference image data to generate a second motion vector of the decoded data and a prediction image data corresponding to the second motion vector.

Then a encoding means encodes a difference between the prediction image data produced by the motion prediction means and the decoded data.

Additional features and advantages of the present invention are described in, and will be apparent from, the following Detailed Description of the Invention and the figures.

### BRIEF DESCRIPTION OF THE FIGURES

FIG. 1 is a view of the configuration of a communication system of an embodiment of the present invention.

FIG. 2 is a functional block diagram of an encoding device shown in FIG. 1.

FIG. 3 is a view for explaining a method for searching for motion vectors in a motion prediction and compensation circuit shown in FIG. 1.

FIGS. 4A and 4B are views for explaining a method for determining a picture type in the encoding device shown in FIG. 1.

FIGS. 5A and 5B are views for explaining an encoding method of the MPEG2.

FIGS. 6A and 6B are views for explaining an encoding method of the H264/AVC.

FIG. 7 is a view for explaining an encoding method by a macro block pair of the H264/AVC.

FIGS. 8A and 8B are views for explaining motion vectors of frame encoding and field encoding.

FIGS. 9A and 9B are views for comparing motion vectors in cases of the MPEG2 and H264/AVC.

FIG. 10 is a view for explaining an operation for generating motion vectors in an MV conversion circuit shown in FIG. 2.

FIG. 11 is a view continued from FIG. 10 for explaining the operation for generating motion vectors in an MV conversion circuit shown in FIG. 2.

FIG. 12 is a flow chart for explaining the processing of the motion prediction and compensation circuit shown in FIG. 2.

FIG. 13 is a view for explaining another processing in the MV conversion circuit of the encoding device shown in FIG. 2.

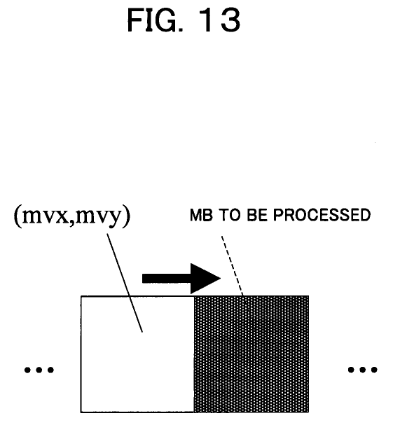

FIG. 14 is a view for explaining another processing in the MV conversion circuit of the encoding device shown in FIG. 2.

FIG. 15 is a view for explaining another processing in the MV conversion circuit of the encoding device shown in FIG. 2.

### DETAILED DESCRIPTION OF THE INVENTION

The present invention relates to a data processing apparatus for determining motion vectors of image data, a method therefor and an encoding device of the same.

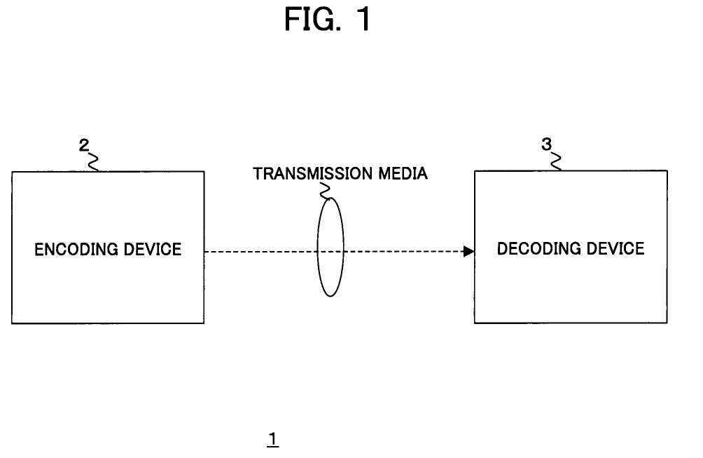

Below, an explanation will be given of an encoding device of the H264/AVC system according to a preferred embodiment of the present invention with reference to FIG. 1 to FIG. 12.

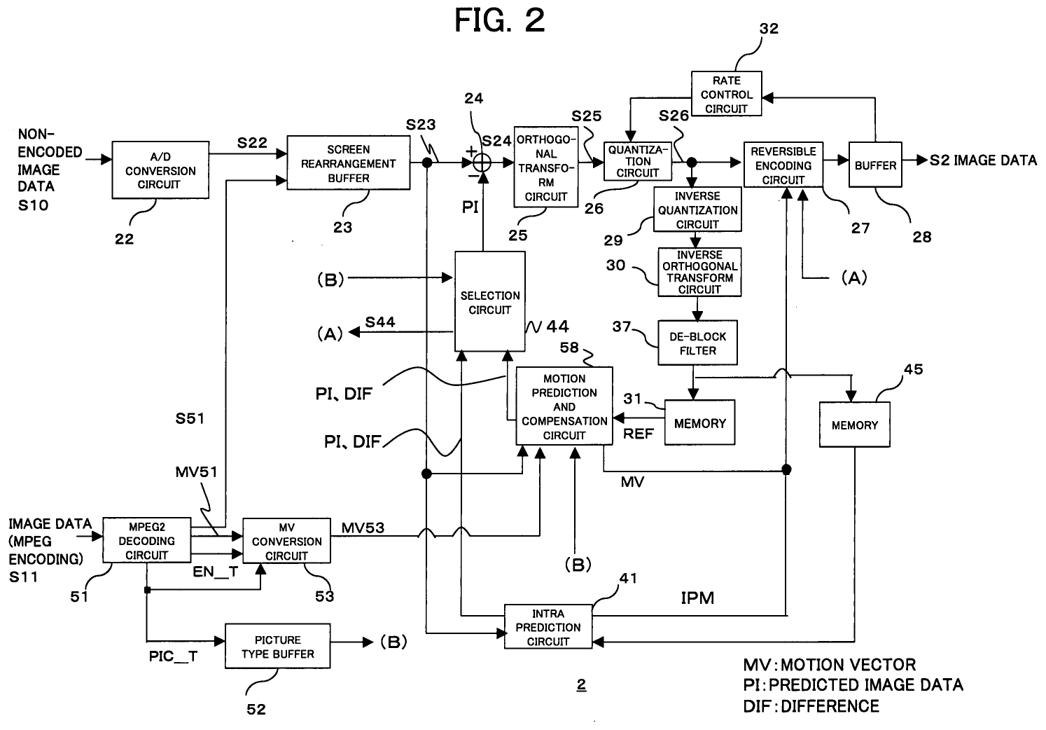

The MPEG2 decoding circuit 51 shown in FIG. 2 corresponds to a decoding means pursuant to an embodiment of the present invention. The MV conversion circuit 53 and motion prediction and compensation circuit 58 shown in FIG. 2 correspond to a motion vector generating means and a motion predicting means pursuant to an embodiment. The screen rearrangement buffer 23 and a reversible encoding circuit 27 shown in FIG. 2 correspond to the encoding means pursuant to an embodiment. The image data S11 corresponds to the encoded data of an embodiment of the present invention, and the image data S51 corresponds to the decoded data of an embodiment of the present invention. Further, the motion vector MV51 corresponds to the first motion vector of an embodiment of the present invention, and the motion vector MV corresponds to the second motion vector of an embodiment of the present invention.

FIG. 1 is a conceptual view of a communication system 1 of the present embodiment. As shown in FIG. 1, the communication system 1 has an encoding device 2 provided on the transmission side and a decoding device 3 provided on the reception side. In the communication system 1, the transmission side encoding device 2 generates frame image data (bit stream) compressed by an orthogonal transform such as a discrete cosine transform or Karhunen-Loeve transform and motion compensation, modulates the frame image data, and transmits the same via a transmission medium such as a satellite broadcast wave, cable TV network, telephone line network, or mobile phone line network. The reception side demodulates the received image signal and expands the result by an inverse transform of the orthogonal transform at the time of modulation and motion compensation to generate frame image data. Note that the transmission medium may be a recording medium such as an optical disc, magnetic disc, semiconductor memory, etc. as well. The decoding device 3 shown in FIG. 1 performs decoding corresponding to the encoding of the encoding device 2.

Below, an explanation will be given of the encoding device 2 shown in FIG. 1. FIG. 2 is a view of the overall configuration of the encoding device 2 shown in FIG. 1. As shown in FIG. 2, the encoding device 2 has for example an A/D conversion circuit 22, a screen rearrangement buffer 23, a processing circuit 24, an orthogonal transform circuit 25, a quantization circuit 26, a reversible encoding circuit 27, a buffer 28, an inverse quantization circuit 29, an inverse orthogonal transform circuit 30, a memory 31, a rate control circuit 32, a memory 45, a de-block filter 37, an intra prediction circuit 41, a selection circuit 44, an MPEG2 decoding circuit 51, a picture type buffer memory 52, an MV conversion circuit 53, and a motion prediction and compensation circuit 58.

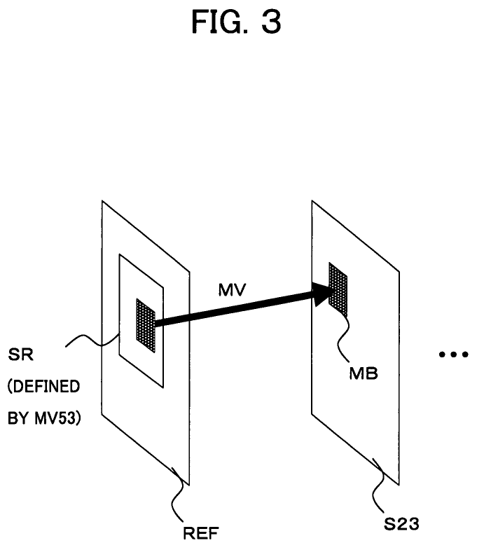

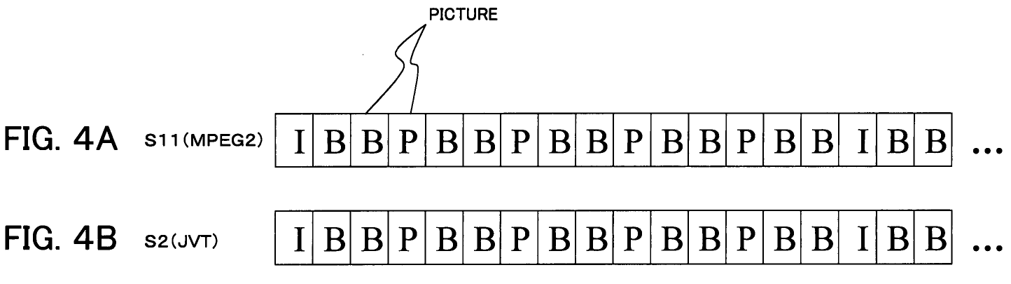

The encoding device 2 decodes the image data S11 encoded by the MPEG2 in the MPEG2 decoding circuit 51 to generate image data S51 and encodes the image data S51 by H264/AVC. In this case, the MPEG2 decoding circuit 51 outputs the motion vector MV51 of each macro block MB determined by the encoding of the MPEG2 to the MV conversion circuit 53. Then, the MV conversion circuit 53 converts the motion vector MV51 and generates a motion vector MV53 for defining the search range of the motion vector. The motion prediction and compensation circuit 58, as shown in FIG. 3, searches the search range SR defined by the motion vector MV53 in the reference image data REF to generate a motion vector MV when generating a motion vector MV of the macro block MB to be processed in the image data S23. The encoding device 2, as shown in FIGS. 4A and 4B, performs the H264/AVC encoding, that is, the generation of the motion vector MV in the motion prediction and compensation circuit 58, by using picture types P, B, and I used in the MPEG2 encoding of pictures of the image data S51 output from the MPEG2 decoding circuit 51 as they are. Note that, in the present embodiment, “I” indicates an I-picture, that is, image data encoded from only the information of the picture in question without any inter-frame prediction (inter prediction encoding). Further, “P” indicates a P-picture, that is, image data encoded by prediction based on the previous (past) I-picture or P-picture in the display sequence. “B” indicates image data encoded by bi-directional prediction based on the I-picture and P-picture before or after the same in the display sequence.

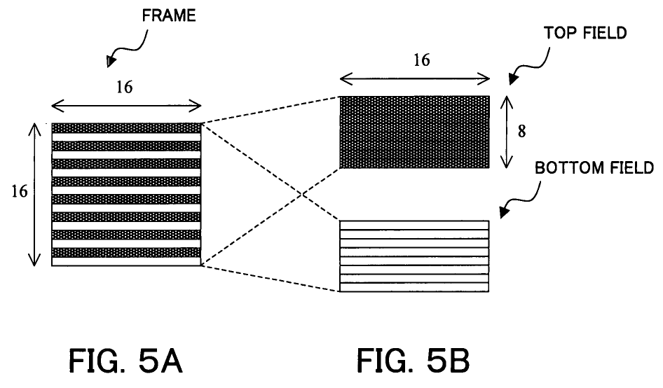

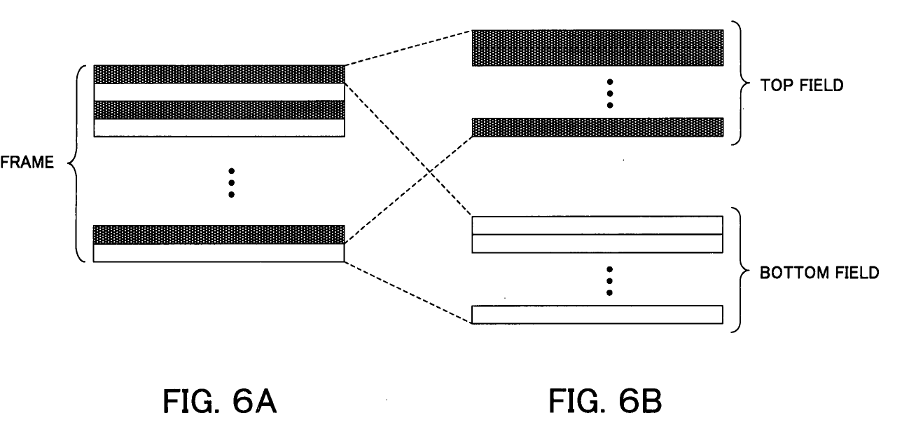

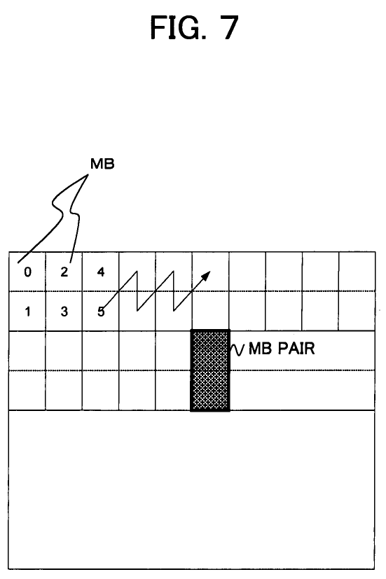

Next, an explanation will be given of the encoding methods of the MPEG2 and H264/AVC. In both the cases of the MPEG2 and H264/AVC, the image data input to the encoding device includes progressive scan image data and interlaced scan image data. Encoding using field data as units (field encoding) and encoding using frame data as units (frame encoding) can be selected. The MPEG2, for example, as shown in FIG. 5A, can perform frame encoding for macro blocks MB comprised of data of 16 pixels×16 pixels or can perform field encoding by dividing them into data of 16 pixels×8 pixels for the top field data and bottom field data as shown in FIG. 5B. Further, the H264/AVC can select encoding in units of pictures as shown in FIGS. 6A and 6B and encoding in units of macro blocks as shown in FIG. 7. As the encoding in units of pictures, the frame encoding shown in FIG. 6A and the field encoding shown in FIG. 6B can be selected. Further, as the encoding in units of macro blocks, a case where the frame encoding or the field encoding is carried out using single macro blocks as units and a case where the frame encoding or the field encoding is carried out using two macro blocks MB (MB pair), that is, data of 16 pixels×32 pixels, as units as shown in FIG. 7 can be selected.

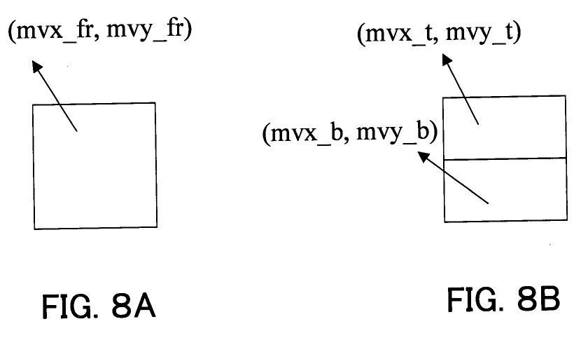

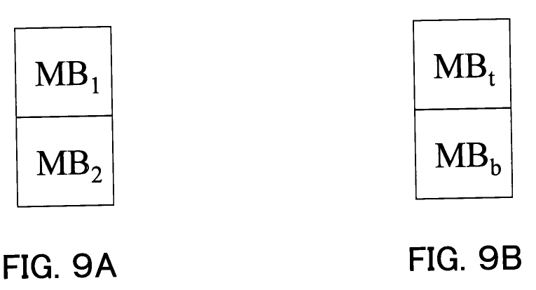

As the motion vector MV of the macro block MB of the MPEG2, there are any of the motion vector obtained by frame encoding (mvx_fr, mvy_fr) as shown in FIG. 8A and the motion vector of the top field data obtained by the field encoding (mvx_t, mvy_j) and the motion vector of the bottom field (mvx_b, mvy_b) as shown in FIG. 8B. As the motion vector MAV of the macro block MB of the MPEG2, when field encoding is carried out, as shown in FIG. 9A, the motion vectors of the top field and the bottom field are included in each of the macro blocks MB1 and MB2 adjacent in a vertical direction. On the other hand, in the H264/AVC, when encoding is carried out using the macro block pair shown in FIG. 7 as a unit, as shown in FIG. 9B, only the motion vector of the top field is included in one macro block MBt, and only the motion vector of the bottom field is included in another macro block MBb.

Below, an explanation will be given of the components of the encoding device 2. The A/D conversion circuit 22 converts an original image signal comprised of an input analog luminance signal Y and color difference signals Pb and Pr to digital image data which it then outputs to the screen rearrangement buffer 23. The screen rearrangement buffer 23 rearranges the image data S22 of the original image input from the A/D conversion circuit 22 or the image data S51 input from the MPEG2 decoding circuit 51 to a sequence of encoding in accordance with a GOP (Group of Pictures) structure comprised of picture types I, P, and B to obtain the image data S23 which it then outputs to the processing circuit 24, the intra prediction circuit 41, and the motion prediction and compensation circuit 58.

The processing circuit 24 generates image data S24 indicating the difference between the image data S23 and the predicted image data PI input from the selection circuit 44 and outputs this to the orthogonal transform circuit 25. The orthogonal transform circuit 25 applies an orthogonal transform such as a discrete cosine transform or Karhunen-Loeve transform to the image data S24 to generate image data (for example DCT coefficient) S25 which it then output to the quantization circuit 26. The quantization circuit 26 quantizes the image data S25 with a quantization scale input from the rate control circuit 32 to generate image data S26 which it then outputs to the reversible encoding circuit 27 and the inverse quantization circuit 29.

The reversible encoding circuit 27 stores the image data obtained by variable length encoding or arithmetic encoding of the image data S26 in the buffer 28. At this time, when the selection data S44 indicates that inter prediction encoding was selected, the reversible encoding circuit 27 encodes the motion vector MV input from the motion prediction and compensation circuit 58 and stores the same in the header data. Further, when the selection data S44 indicates that intra prediction encoding was selected, the reversible encoding circuit 27 stores the intra prediction mode IMP input from the intra prediction circuit 41 in the header data etc.

The image data stored in the buffer 28 is modulated, then transmitted. The inverse quantization circuit 29 generates a signal by the inverse quantization of the image data S26 and outputs this to the inverse orthogonal transform circuit. The inverse transform circuit 30 applies an inverse transform of the orthogonal transform in the orthogonal transform circuit 25 to the image data input from the inverse quantization circuit 29 and outputs the thus generated image data to the de-block filter 37. The de-block filter 37 writes the image data obtained by eliminating the block distortion of the image data input from the inverse orthogonal transform circuit 30 into memories 31 and 45. The rate control circuit 32 generates the quantization scale based on the image data read out from the buffer 23 and outputs this to the quantization circuit 26.

The intra prediction circuit 41 applies intra prediction encoding to the macro blocks MB composing the image data read out from the memory 45 based on each of intra prediction modes defined in advance by for example the H264/AVC to generate the predicted image and detects the difference DIF between the predicted image data and the image data S23. Then, the intra prediction circuit 41 specifies the intra prediction mode corresponding to the minimum difference among the above differences generated for the above plurality of intra prediction modes and outputs the specified intra prediction mode IPM to the reversible encoding circuit 27. Further, the intra prediction circuit 41 outputs the predicted image data PI based on the above specified intra prediction mode and the difference DIF to the selection circuit 44.

The selection circuit 44 compares the difference DIF input from the intra prediction circuit 44 and the difference DIF input from the motion prediction and compensation circuit 58. When deciding that the difference DIF input from the intra prediction circuit 41 is smaller by the above comparison, the selection circuit 44 selects the predicted image data PI input from the intra prediction circuit 41 and outputs it to the processing circuit 24. When deciding that the difference DIF input from the motion prediction and compensation circuit 58 is smaller by the above comparison, the selection circuit 44 selects the predicted image data PI input from the motion prediction and compensation circuit 58 and outputs it to the processing circuit 24. Further, the selection circuit 44 outputs selection data S44 indicating that the inter prediction encoding was selected to the reversible encoding circuit 27 when selecting the predicted image data PI from the intra prediction circuit 41 and outputs selection data S44 indicating that the intra prediction encoding was selected to the reversible encoding circuit 27 when selecting the predicted image data PI from the motion prediction and compensation circuit 58.

The MPEG2 decoding circuit 51 receives as input the image data S11 encoded by for example the MPEG2, decodes the image data S11 by the MPEG2 to generate the image data S51, and outputs this to the screen rearrangement buffer 23. The MPEG2 decoding circuit 51 outputs the motion vector MV51 of the macro blocks MB included in the header of the image data S11 to the MV conversion circuit 53. Further, the MPEG2 decoding circuit 51 outputs picture type data PIC_T included in the header of the image data S11 and indicating the type of the picture of each macro block MB to the MV conversion circuit 53 and, at the same time, writes the same into the picture type buffer memory 52. Further, the MPEG2 decoding circuit 51 outputs the encoding type data EN_T indicating whether the encoding of the macro block MB by the MPEG2 is intra encoding or inter encoding and, in the case of inter encoding, indicating either of the prediction mode, field encoding, or frame encoding to the MV conversion circuit 53.

The picture type data PIC_T stored in the picture type buffer memory 52 is read out by the selection circuit 44 and the motion prediction and compensation circuit 58.

The MV conversion circuit 53 generates the motion vector MV53 based on the motion vector MV51 input from the MPEG2 decoding circuit 51 and outputs it to the motion prediction and compensation circuit 58. The motion vector MV53, as explained by using FIG. 3, is used for defining the search range SR in the reference image data REF when searching for the motion vector MV by the H264/AVC method in the motion prediction and compensation circuit 58.

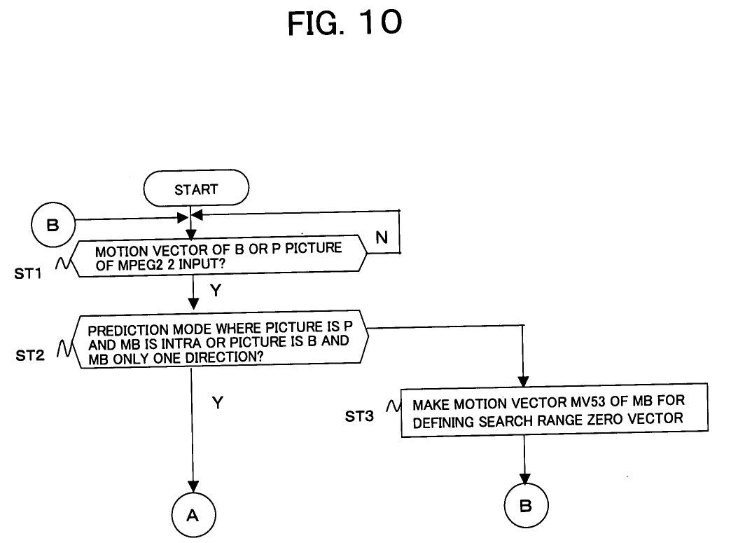

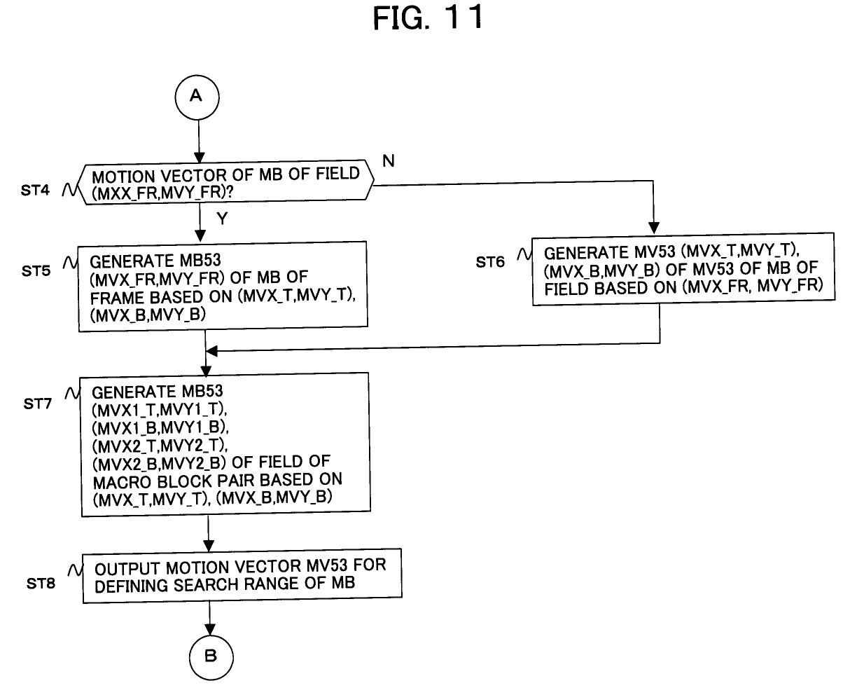

Below, an explanation will be given of the operation for generation of the motion vector MV53 in the MV conversion circuit 53 with reference to FIG. 10 and FIG. 11.

Step ST1

The MV conversion circuit 53 decides the picture type of the macro block MB corresponding to the motion vector MV51 input from the MPEG2 decoding circuit 51 based on the picture type data PIC_T input from the MPEG2 decoding circuit 51. When the picture type is B or P, it proceeds to step ST2, while when it is not, it repeats the processing of step ST 1.

Step ST2

The MV conversion circuit 53 decides whether or not either the condition that “the picture type of the macro block MB is P and intra encoded” or the condition that “the picture type of the macro block MB is B and the prediction mode is only forward prediction or backward prediction” is satisfied based on the picture type data PIC_T and the encoding type data EN_T input from the MPEG2 decoding circuit 51, proceeds to step ST3 when deciding neither condition is satisfied, and proceeds to step ST4 when deciding that one condition is satisfied.

Step ST3

The MV conversion circuit 53 selects a zero vector as the motion vector MV53.

Step ST4

The MV conversion circuit 53 decides whether or not the motion vector MV51 is obtained by field encoding based on the encoding type data EN_T, proceeds to step ST5 when deciding that the motion vector MV51 was field encoded, and proceeds to step ST6 when deciding it was not (case where the motion vector MV51 was frame encoded). Note that when the motion vector MV51 is obtained by field encoding the macro block MB, as the motion vector MV51, as shown in FIG. 8B, there may be the motion vector of the top field (mvx_t, mvy_t) and the motion vector of the bottom field (mvx_b, mvy_b). On the other hand, when the motion vector MV51 is obtained by frame encoding the macro block MB, as the motion vector MV51, as shown in FIG. 8A, there is the motion vector of the frame data (mvx_fr, mvy_fr).

Step ST5

The MV conversion circuit 53 generates the motion vector of the frame data (mvx_fr, mvy_fr) based on equations (1) by using the motion vector of the top field (mvx_t, mvy_t) and the motion vector of the bottom field (mvx_b, mvy_b) defined by the motion vector MV51 of the macro block MB.

| | |
|---|---|
| mvx_fr=(mvx_t+mvx_b)/2 | |
| mvy_fr=mvy_t+mvy_b | (1) |
| Step ST6 | |

The MV conversion circuit 53 generates the motion vector of the top field (mvx_t, mvy_j) and the motion vector of the bottom field (mvx_b, mvy_b) based on equations (2) by using the motion vector of the frame data (mvx_fr, mvy_fr) defined by the motion vector MV51 of the macro block MB.

| | |
|---|---|
| mvx_t=mvy_b=mvx_fr | |
| mvy_t=mvy_b=(mvy_fr)/2 | (2) |
| Step ST7 | |

The MV conversion circuit 53 uses the motion vectors (mvx1_t, mvy1_t), (mvx1_b, mvy1_b), (mvx2_t, mvy2_t), and (mvx2_b, mvy2_b) of the fields of two macro blocks MB of the MPEG2 corresponding to the macro block pair defined by the H264/AVC and generates the motion vectors (mvx_t, mvy_t) and (mvx_b, mvy_b) used for defining the search range by motion compensation using the field data of the macro block pair explained using FIG. 7, FIGS. 9A and 9B as units based on equations (3).

| | |
|---|---|
| mvx_t=(mvx1_t+mvx2_t)/2 | |
| mvy_t=(mvy1_t+mvy2_t)/2 | |
| mvx_b=(mvx1_b+mvx2_b)/2 | |
| mvy_b=(mvy1_b+mvy2_b)/2 | (3) |
| Step ST8 | |

The MV conversion circuit 53 outputs the motion vectors generated at steps ST3, ST5, ST6, and ST7 as the motion vector MV53 to the motion prediction and compensation circuit 58.

The motion prediction and compensation circuit 58 determines the motion vector MV based on the reference image data REF read out from the memory 31 using the frame data and the field data as units for the image data S23. Namely, the motion prediction and compensation circuit 58 determines the motion vector MV making the difference DIF between the predicted image data PI defined by the motion vector MV and the reference image data REF and the image data S23 the minimum. At this time, the motion prediction and compensation circuit 58 searches for the motion vector MV within the search range defined by the motion vector MV53 in the reference image data REF and determines the same.

The motion prediction and compensation circuit 58, when generating the motion vector MV using the frame data as units, generates the motion vector MV based on the reference image data REF (frame data) read out from the memory 31 using the field data of the image data S23 as units. Namely, the motion prediction and compensation circuit 58 determines the motion vector MV and generates the predicted image data PI and the difference DIF by using the frame data shown in FIG. 6A as units.

The motion prediction and compensation circuit 58, when generating the motion vector MV by using the field data as units, determines the motion vector MV based on the reference image data REF (field data) read out from the memory 31 by using the field data of the image data S23 as units. Namely, the motion prediction and compensation circuit 58 determines the motion vector MV and generates the predicted image data PI and the difference DIF by using each of the top field data and the bottom field data shown in FIG. 6B as units. The motion prediction and compensation circuit 58 outputs the predicted image data PI and the difference DIF to the selection circuit 44 and outputs the motion vector MV to the reversible encoding circuit 27. Note that, in the present embodiment, the motion prediction and compensation circuit 58 does not use the multiple reference frame option defined by the H264/AVC, but uses one reference image data REF for the P-picture and uses two reference image data REF for the B-picture.

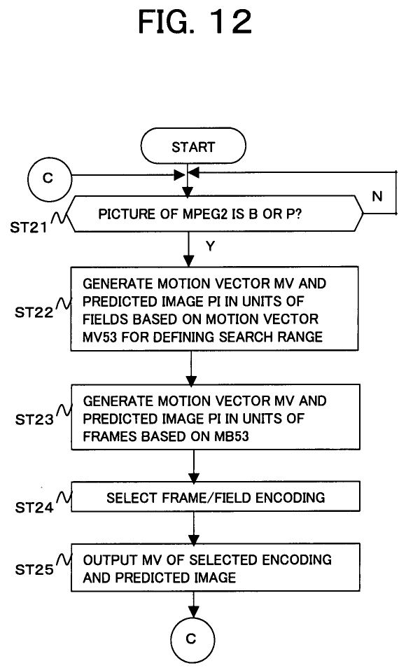

Below, a detailed explanation will be given of the processing of the motion prediction and compensation circuit 58. FIG. 12 is a flow chart for explaining the processing of the motion prediction and compensation circuit 58.

Step ST21

The motion prediction and compensation circuit 58 decides whether or not the macro block MB to be processed in the image data S23 is a B- or P-picture based on the picture type data PIC_T input from the picture type buffer memory 52. When deciding it as the B- or P-picture, it proceeds to step ST22, while when not, it repeats the processing of step ST21.

Step ST22

The motion prediction and compensation circuit 58 selects the motion vector corresponding to field encoding among motion vectors input as the motion vector MV53. Then, the motion prediction and compensation circuit 58 defines the search range SR in one or more reference image data REF (field data) selected in accordance with the picture type of the macro block MB to be processed by the above selected motion vector. Then, the motion prediction and compensation circuit 58 generates the motion vector MV of the macro block MB to be processed by searching the search range SR in the above defined reference image data REF in units of frame data. At this time, the motion prediction and compensation circuit 58 generates the predicted image data PI and the difference DIF between the reference image data REF and the predicted image data PI based on the motion vector MV and the reference image data REF.

Step ST23

The motion prediction and compensation circuit 58 selects the motion vector corresponding to frame encoding among the motion vectors input as the motion vector MV53. Then, the motion prediction and compensation circuit 58 defines the search range SR in one or more reference image data REF (frame data) selected in accordance with the picture type of the macro block MB to be processed by the above selected motion vector. Then, the motion prediction and compensation circuit 58 generates the motion vector MV of the macro block MB to be processed by searching the search range SR in the above defined referenced image data REF in units of frame data. The motion prediction and compensation circuit 58 generates the motion vector MV for each of the case where a single macro block MB is used as the unit and a case where an MB pair shown in FIG. 7 is used as the unit. At this time, the motion prediction and compensation circuit 58 generates the predicted image data PI and the difference DIF between the reference image data REF and the predicted image data PI based on the motion vector MV and the reference image data REF. The motion prediction and compensation circuit 58 performs processings of steps ST22 and ST23 for all macro blocks MB in the picture to be processed.

Step ST24

The motion prediction and compensation circuit 58 selects encoding giving the smallest sum of differences DIF for all macro blocks MB in the picture to be processed between the frame encoding and the field encoding based on the differences DIF generated at steps ST22 and ST23. Further, the motion prediction and compensation circuit 58 selects which of the macro block MB or the MB pair is to be used as a unit when selecting the frame encoding.

Step ST25

The motion prediction and compensation circuit 58 outputs the motion vector MV corresponding to the frame encoding or the field encoding selected at step ST58 to the reversible encoding circuit 27 and outputs the predicted image data PI corresponding to that and the difference DIF to the selection circuit 44.

Below, an explanation will be given of the overall operation of the encoding device 2 shown in FIG. 2.

First Example of Operation

In the first example of operation, an explanation will be given of a case where not encoded image data S10 is input to the encoding device 2. When the image data S10 which is not encoded is input, the image data S10 is converted to the image data S22 in the A/D conversion circuit 22. Next, the screen rearrangement buffer 23 rearranges the pictures in the image data S10 in accordance with the GOP structure of the image compression information for output and outputs the image data S23 obtained by that to the processing circuit 24, the intra prediction circuit 41, and the motion prediction and compensation circuit 58. Next, the processing circuit 24 detects the difference between the image data S23 from the screen rearrangement buffer 23 and the predicted image data PI from the selection circuit 44 and outputs the image data S24 indicating the difference to the orthogonal transform circuit 25.

Next, the orthogonal transform circuit 25 applies an orthogonal transform such as a discrete cosine transform or Karhunen-Loeve transform to the image data S24 to generate the image data S25 and outputs this to the quantization circuit 26. Next, the quantization circuit 26 quantizes the image data S25 and outputs the quantized image data S26 to the reversible encoding circuit 27 and the inverse quantization circuit 29. Next, the reversible encoding circuit 27 applies reversible encoding such as variable length encoding or arithmetic encoding to the image data S26 to generate the image data S28 and stores this in the buffer 28. Further, the rate control circuit 32 controls the quantization rate in the quantization circuit 26 based on the image data S28 read out from the buffer 28.

The inverse quantization circuit 29 inversely quantizes the image data S26 input from the quantization circuit 26 and outputs the inversely quantized transform coefficient to the inverse orthogonal transform circuit 30. The inverse orthogonal transform circuit 30 applies an inverse transform of the orthogonal transform in the orthogonal transform circuit 25 to the image data input from the inverse quantization circuit 29 to generate the image data and outputs the same to the de-block filter 37. The de-block filter 37 writes the image data obtained by eliminating the block distortion of the image data input from the inverse orthogonal transform circuit 30 into the memories 31 and 45.

Then, the intra prediction circuit 41 performs the intra prediction encoding as mentioned above and outputs the predicted image data PI thereof and the difference DIF to the selection circuit 44. Further, the motion prediction and compensation circuit 58 determines the motion vector MV. The motion prediction and compensation circuit 58 also generates the predicted image data PI and the difference DIF and outputs them to the selection circuit 44. Then, the selection circuit 44 outputs the predicted image data PI corresponding to the smaller difference DIF between the difference DIF input from the intra prediction circuit 41 and the difference DIF input from the motion prediction and compensation circuit 58 to the processing circuit 24.

Second Example of Operation

In the second example of operation, for example, an explanation will be given of the case where image data S11 encoded by the MPEG2 is input to the encoding device 2. The image data S11 encoded by the MPEG2 is input to the MPEG2 decoding circuit 51.

Then, the MPEG2 decoding circuit 51 decodes the image data S11 encoded by the MPEG2 to generate the image data S51 and outputs this to the screen rearrangement buffer 23. The MPEG2 decoding circuit 51 also outputs the motion vector MV51 of each macro block MB included in the header of the image data S11 to the MV conversion circuit 53. Further, the MPEG2 decoding circuit 51 outputs the picture type data PIC_T indicating the type of the picture of each macro block MB included in the header of the image data S11 to the MV conversion circuit 53 and, at the same time, writes the same into the picture type buffer memory 52. Further, the MPEG2 decoding circuit 51 outputs the encoding type data EN_T indicating whether the encoding of the macro block MB by the MPEG2 is intra encoding or inter encoding and, in the case of inter encoding, indicating either of the prediction mode, field encoding, or frame encoding, to the MV conversion circuit 53.

The MV conversion circuit 53 performs the processing explained by using FIG. 10 and FIG. 11 to convert the motion vector MV51 and generate the motion vector MV53. Then, the motion prediction and compensation circuit 58 performs the processing shown in FIG. 12 based on the motion vector MV53. Namely, the motion prediction and compensation circuit 58, when generating the motion vector MV of the macro block MB to be processed in the image data S23, searches the search range SR defined by the motion vector MV53 in the reference image data REF to generate the motion vector MV. At this time, the motion prediction and compensation circuit 58, as shown in FIGS. 4A and 4B, generates the motion vector MV by using the picture types P, B, and I used in the MPEG2 encoding of the pictures of the image data S11 output from the MPEG2 decoding circuit 51 as they are.

As explained above, the encoding device 2 generates the motion vector MV53 based on the motion vector MV51 of the image data S11 obtained at the MPEG2 decoding circuit 51, and the motion prediction and compensation circuit 58 searches the search range SR defined by the motion vector MV53 in the reference image data REF to generate the motion vector MV. For this reason, according to the encoding device 2, in comparison with the case where the reference image data of ¼ resolution is generated by thinning out the reference image data REF and the motion vector MV is generated by using the entire reference image data as the search range as in the conventional case, the amount of processing of the motion prediction and compensation circuit 58 can be greatly reduced and a shortening of the generation time of the motion vector MV and a reduction of scale of the circuit can be achieved. Further, according to the encoding device 2, by making the picture types of pictures the same between the image data S11 and the image data S2 and performing the processings shown in FIG. 10 and FIG. 11 to generate the motion vector MV53, a suitable search range can be determined and a high quality motion vector MV can be generated. As a result, a high encoding efficiency can be realized as in the past.

In the above embodiments, the MPEG2 was illustrated as the first encoding of the present invention, and the H264/AVC was illustrated as the second encoding of the present invention, but other encoding can be used too as the first encoding and second encoding of the present invention. For example, as the second encoding of the present invention, use can be also made of for example the MPEG-4 or AVC/H.264.

Further, in the above embodiments, the case where the MV conversion circuit 53 output a zero vector as the motion vector MV53 at step ST3 shown in FIG. 10 was illustrated, but use can be also made of for example the motion vector MV51 of a macro block MB at the periphery of the target macro block MB in the image data S11 as the motion vector MV53. Further, other than this, it is also possible if the MV conversion circuit 53 uses the motion vector MV51 (mvz, mvy) of the macro block MB located immediately before the target macro block MB in the image data S11 in the raster scanning order as the motion vector MV53.

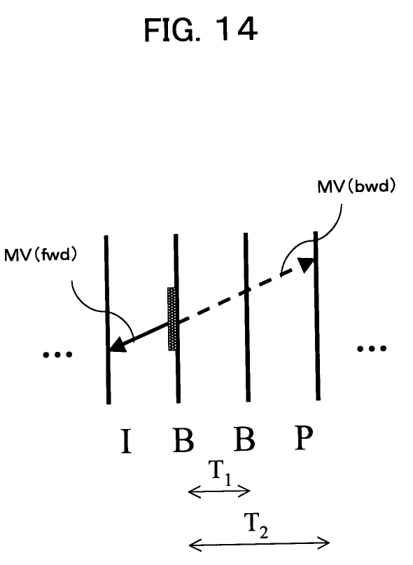

Further, when the macro block MB to be processed is a B-picture and one of the forward prediction mode or the backward prediction mode is used, it is also possible if the MV conversion circuit 53 uses a zero vector as the motion vector MV53 of the other prediction mode. Other than this, in this case, it is also possible to prohibit bi-directional prediction by the motion prediction and compensation circuit 58. Further, it is also possible if the MV conversion circuit 53 generates the motion vector MV53 of the backward prediction mode based on “MV(bwd)=−(T₁/T₂)×MV(fwd)” by using the motion vector MV51 of the forward prediction mode and the Temporal_Reference information included in the image data S11 as shown in FIG. 14.

Further, in place of the processing of step ST7 shown in FIG. 11, for example, if MV conversion circuit 53 selects the macro block MB having a lower generated code amount between the macro blocks MB1 and MB2 shown in FIGS. 9A and 9B and defines this as a macro block MBz, if making the motion vectors MV of the field data unit (mvxz_t, mvyz_t) and (mvxz_b, mvyz_b), it is also possible to generates the motion vectors (mvx_t, mvy_t) and (mvx_b, mvy_b) used for defining the search range in the motion compensation using the field data of the macro block pair explained by using FIG. 7, FIGS. 9A and 9B as units based on equations (4). Here, the generated code amount may be the amount of information of the DCT transform coefficient included in the image data S11 or the sum of the amount of information of the DCT transform coefficient and the amount of information of the header portion of the motion vector MV51.

| mvx_t=mvxz_t | |
|---|---|
| mvy_t=mvyz_t | |
| mvx_b=mvxz_b | |
| mvy_b=mvyz_b | (4) |

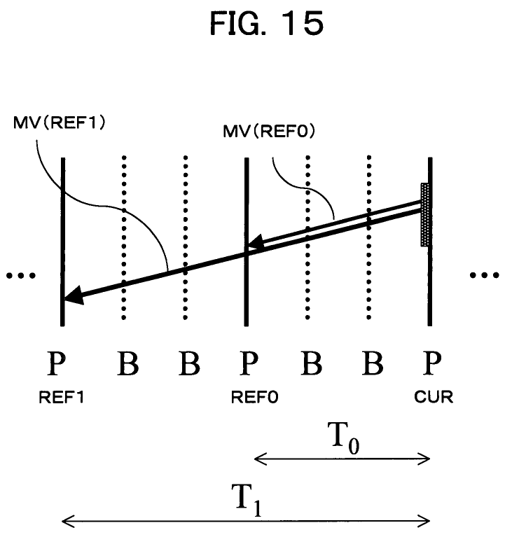

Further, in the above embodiments, the case where the motion prediction and compensation circuit 58 did not use the multiple reference frame option defined by the H264/AVC was illustrated, but it is also possible to use the multiple reference frame option. In this case, as shown in FIG. 15, the P-picture in processing is defined as P(CUR), the first reference frame is defined as P(REF0), and the second reference frame is defined as P(REF1). Further, the motion vector of P(REF0) is defined as MV (REF0), and the motion vector of P (REF1) is defined as MV (REF1). The image data S11 is not subjected to the multiply reference frame option, therefore, for example MV (REF0) exists as the motion vector MV51, but there is a case where the P(REF1) does not exist. Accordingly, the MV conversion circuit 53 generates the motion vector MV (REF1) based on equation (5) by using for example the motion vector MV (REF0) input from the MPEG2 decoding circuit 51 as the motion vector MV51.
MV(REF1)=(T₁/T₀)×MV(REF0) (5)

Summarizing the effects of the invention, it is possible to provide a data processing apparatus capable of reducing the amount of processing accompanying the determination of a motion vector without causing a deterioration of the encoding efficiency when encoding motion image data by a first encoding method, decoding this encoded data, and encoding the obtained decoded data by a second encoding method and a method and an encoding device of the same.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A data processing apparatus comprising:
a decoding means for decoding a coded data obtained by encoding a moving image data based on a first encoding method to produce a decoded data; and
a motion vector generating means for determining a search range in a reference image data based on a first motion vector included in the coded data and searching through the search range in the reference image data to generate a second motion vector of the decoded data thereby encoding the decoded data produced by the decoding means based on a second encoding method that is different than the first encoding method.

2. The data processing apparatus of claim 1, wherein
the motion vector generating means generates the second motion vector based on a motion vector generating method different to that of the first encoding method.

3. The data processing apparatus of claim 1, wherein
the first motion vector is generated in units of a frame data, and the second motion vector of the decoded data is generated in units of field data,
the motion vector generating means generates a thirds motion vector corresponding to a first field data among the first field data and a second field data forming a same frame data of the decoded data and a fourth motion vector corresponding to a second field data based on the first motion vector, searches the search range in the reference image data determined based on the third motion vector to produce the second motion vector of the first field data and searches the search range in the reference image data determined based on the fourth motion vector to generate the second motion vector of the second field data.

4. The data processing apparatus of claim 1, wherein
the motion vector generating means generates a third motion vector (mvx_t,mvy_t) and a fourth motion vector (mvx_b,mvy_b) by using the first motion vector (mvx_fr,mvy_fr) based on equations as follows:
mvx_t=mvy_b=mvx_fr
mvy_{—}t=mvy_{—}b=(mvy_{—}fr)/2

5. The data processing apparatus of claim 1, wherein
the first motion vector has been generated in units of a field data, the second motion vector is generated in units of a frame data,
the motion vector generating means generates a fifth motion vector based on the first motion vector of each of a first field data and a second field data forming a same frame data of the encoded data, searches the search range in the reference image data determined based on the fifth motion vector to generate the second motion vector corresponding to the frame data.

6. The data processing apparatus of claim 5, wherein
the motion vector generating means generates a fifth motion vector (mvx_fr,mvy_fr) by using the first motion vector (mvx_t,mvy_t) of the first field data and the second motion vector (mvx_b,mvy_b) of the second field data based on an equation as follows:
mvx_{—}fr=(mvx_{—}t+mvx_{—}b)/2
mvy_{—}fr=mvy_{—}t+mvy_{—}b

7. The data processing apparatus of claim 1, wherein
the motion vector generating means generates a sixth motion vector based on the first motion vector and determines the search range based on the sixth motion vector.

8. The data processing apparatus of claim 7, wherein
the coded data is intra coded data, the decoded data is inter-coded, and the motion vector generating means generates zero vector as the sixth motion vector.

9. The data processing apparatus of claim 1, wherein
the moving image data is coded in units of a predetermined block data, the block data to be processed is inter-coded, the first motion vector corresponding to the block data to be processed does not exist,
the motion vector generating means determines the search range based on the first motion vector of the block data except for the block data to be processed.

10. The data processing apparatus of claim 7, wherein
the coded data is obtained by encoding by field the moving image data in units of a predetermined block data, the first motion vector of the block data of each of the first field data and the second field data forming the same frame data are corresponded to each of the block data,
the encoded data is obtained by encoding by field in units of two block data, the second motion vector of the block data of the first field data corresponds to the one of the two block data, the second motion vector of the second field data corresponds to the other of the two block data,
the motion vector generating means generates the sixth motion vector of one of the two block data and the sixth block data of the other of the two block data based on the first motion vector of the block data of both of the first field data and the second field data.

11. The data processing apparatus of claim 1, wherein
a first type in which the coded data is obtained by intra-encoding, a second type in which the coded data is obtained by encoding referring the frame data or field data being displayed before the coded data and third type in which the encoded data is obtained by encoding referring the frame data and the field data of at least one of type among the first type and the second type,
the motion vector generating means generates the second motion vector of the frame data or the field data in the decoded data based on the type of the frame data or the field data of the corresponding coded data.

12. The data processing method comprising:
a first step for decoding a coded data obtained by encoding a moving image data on the basis of a first encoding method to produce a decoded data;
a second step for determining a search range in a reference image data based on a first motion vector included in the coded data to encode the decoded data produced by the first step based on a second encoding method different to the first encoding method; and
a third step for searching through the search range determined in the second step in the reference image data to generate a second motion vector of the decoded data.

13. An encoding device comprising,
a decoding means for decoding a coded data obtained by encoding a moving image data based on a first encoding method to produce a decoded data;
a motion prediction means for determining a search range in a reference image data based on a first motion vector included in the coded data and searching through the search range in the reference image data to generate a second motion vector of the decoded data and a prediction image data corresponding to the second motion vector in order to encode the decoded data produced by the decoding means based on a second encoding method different to the first encoding method; and
a encoding means for encoding a difference between the prediction image data produced by the motion prediction means and the decoded data.
